(19) United States
(12) Patent Application Publication
(10) Pub. No.: US 2009/0266800 A1
(43) Pub. Date: Oct. 29, 2009

(54) LASER PROCESSING METHOD FOR TRANSPARENT PLATE

(75) Inventors: Hiroshi Morikazu, Tokyo (JP); Keiji Honjo, Tokyo (JP); Kenji Asano, Tokyo (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/414,975

(22) Filed: Mar. 31, 2009

(30) Foreign Application Priority Data
Apr. 24, 2008 (JP) 2008-113846

(51) Int. Cl. B23K 26/00

(52) U.S. Cl. 219/121.61; 219/121.72

(57) ABSTRACT

A laser processing method for a transparent plate having a predetermined breaking line including the step of applying a pulsed laser beam to the transparent plate along the breaking line to thereby form a laser processed groove. The pulsed laser beam has an absorption wavelength to the transparent plate. The repetition frequency of the pulsed laser beam is set to 200 kHz or more and the energy density per pulse of the pulsed laser beam is set to 3.8 J/cm² or more.

### BACKGROUND OF THE INVENTION

1. Field of the Invention

The present invention relates to a laser processing method for a transparent plate such as a glass substrate constituting a liquid crystal device, in which a laser processed groove is formed along a predetermined breaking line on the transparent plate.

2. Description of the Related Art

A liquid crystal device is formed by stacking a silicon substrate and a glass substrate. A liquid crystal filling port is formed on a separate surface between the silicon substrate and the glass substrate, and a liquid crystal chamber is defined between the silicon substrate and the glass substrate. A liquid crystal is filled from the liquid crystal filling port into the liquid crystal chamber. In this liquid crystal device, electrodes are formed on the inner surface of the silicon substrate, i.e., on the surface exposed to the liquid crystal chamber. These electrodes are exposed by breaking the glass substrate along a predetermined breaking line to thereby remove a portion of the glass substrate above these electrodes.

The glass substrate of the liquid crystal device is broken along the breaking line by using a point scriber to form a scribe line along the breaking line on the outer surface of the glass substrate and next applying an external force to the glass substrate along this scribe line (see Japanese Patent Laid-Open Nos. Hei 6-3633 and Hei 9-309736, for example).

In this method of breaking the glass substrate by forming the scribe line along the breaking line on the outer surface of the glass substrate and next applying an external force along this scribe line, there is a possibility that the glass substrate may not be reliably broken along the breaking line, causing a reduction in yield. Accordingly, this method is not always satisfactory from the viewpoint of productivity.

The present inventors have attempted to perform a method of breaking a glass substrate along a breaking line by applying a pulsed laser beam having an absorption wavelength to the glass substrate along the breaking line on the outer surface of the glass substrate to thereby form a laser processed groove along the breaking line on the outer surface of the glass substrate and next applying an external force to the glass substrate along this laser processed groove.

However, according to the experiment conducted by the present inventors, it has been found that the pulsed laser beam may pass through the glass substrate to damage the electrodes formed on the inner surface of the silicon substrate. Further, according to the experiment conducted by the present inventors, it has also been found that when the repetition frequency of the pulsed laser beam applied to the glass substrate is low, the application period of pulses is long, so that a cooling time becomes long and a tensile stress due to cooling is generated to cause cracks in the glass substrate.

### SUMMARY OF THE INVENTION

It is therefore an object of the present invention to provide a laser processing method for a transparent plate such as a glass plate which can form a laser processed groove on the transparent plate without the generation of cracks.

In accordance with an aspect of the present invention, there is provided a laser processing method for a transparent plate having a predetermined breaking line, including the step of applying a pulsed laser beam having an absorption wavelength to the transparent plate along the breaking line to form a laser processed groove, wherein the repetition frequency of the pulsed laser beam is set to 200 kHz or more and the energy density per pulse of the pulsed laser beam is set to 3.8 J/cm² or more.

Preferably, the repetition frequency of the pulsed laser beam is set to 400 kHz or more and the energy density per pulse of the pulsed laser beam is set to 8 J/cm² or more.

Preferably, the pulse width of the pulsed laser beam is set to 10 ns or less. Preferably, the rate of overlapping of focused spots of the pulsed laser beam is set to 50% or more.

According to the present invention, the pulsed laser beam to be applied to the transparent plate has an absorption wavelength to the transparent plate. Further, the repetition frequency of the pulsed laser beam is 200 kHz or more and the energy density per pulse of the pulsed laser beam is 3.8 J/cm² or more. Accordingly, the laser processed groove can be formed on the transparent plate without the generation of cracks in the transparent plate.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a liquid crystal device to be processed by the laser processing method according to the present invention;

FIG. 2 is a side view of the liquid crystal device shown in FIG. 1;

FIG. 3 is a perspective view of the liquid crystal device shown in FIG. 1 in the condition where it is attached to a holding tape mounted on an annular frame;

FIG. 4 is a perspective view showing an essential part of a laser processing apparatus for performing the laser processing method according to the present invention;

FIG. 5 is a block diagram schematically showing the configuration of laser beam applying means included in the laser processing apparatus shown in FIG. 4;

FIGS. 6A and 6B are side views for illustrating a laser beam applying step in the laser processing method according to the present invention applied to a glass substrate constituting the liquid crystal device shown in FIG. 1;

FIG. 6C is a sectional view showing a laser processed groove formed on the glass substrate by the laser beam applying step shown in FIGS. 6A and 6B;

FIG. 7 is a graph showing experimental data obtained by measuring the depth of a laser processed groove formed on a glass plate by applying a pulsed laser beam at different repetition frequencies;

FIG. 8 is a side view showing a breaking step for breaking the glass substrate of the liquid crystal device along the laser processed groove by applying an external force to the glass substrate after the laser beam applying step; and

FIG. 9 is a perspective view of the liquid crystal device obtained by the breaking step shown in FIG. 8.

### DETAILED DESCRIPTION OF THE PREFERRED EMBODIMENTS

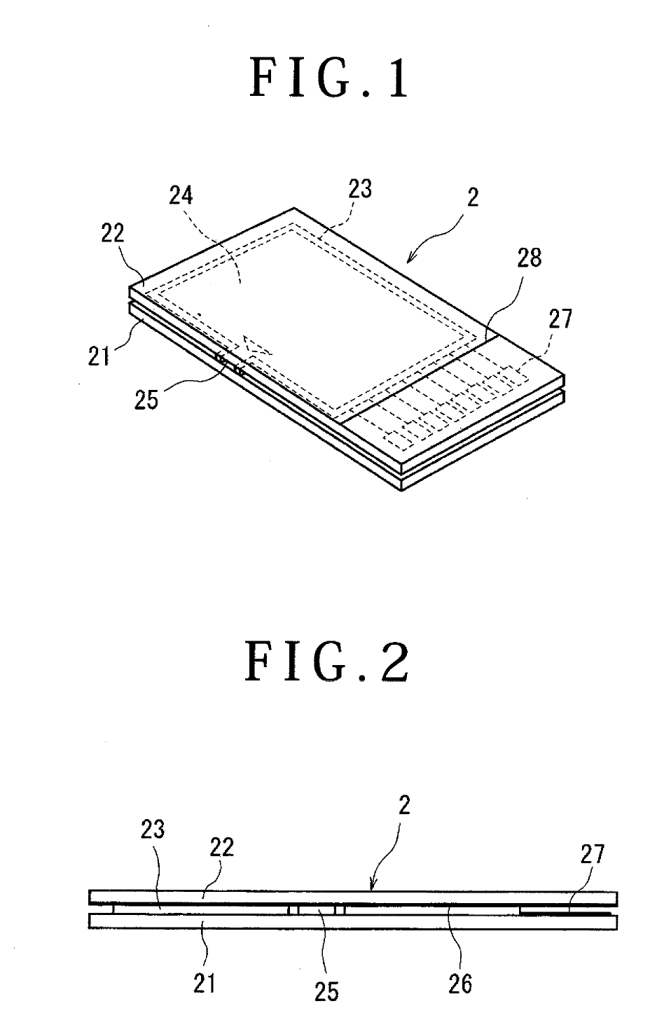

A preferred embodiment of the laser processing method according to the present invention will now be described in detail with reference to the attached drawings. FIG. 1 is a perspective view of a liquid crystal device 2 to be processed by the laser processing method according to the present invention, and FIG. 2 is a side view of the liquid crystal device 2 shown in FIG. 1. The liquid crystal device 2 shown in FIGS. 1 and 2 is composed of a silicon substrate 21 and a glass substrate 22. A liquid crystal chamber 24 is defined between the silicon substrate 21 and the glass substrate 22 so as to be surrounded by a sealing member 23. The sealing member 23 is formed with a liquid crystal filling port 25 communicating with the liquid crystal chamber 24 and opening to one end surface of the liquid crystal device 2.

A transparent conductive film 26 of indium tin oxide or the like is formed by evaporation on the inner surface of the glass substrate 22, i.e., on the surface exposed to the liquid crystal chamber 24. On the other hand, a plurality of driving electrodes 27 are formed on the inner surface of the silicon substrate 21 of the liquid crystal device 2, i.e., on the surface exposed to the liquid crystal chamber 24 so as to be located adjacent to the sealing member 23 defining the liquid crystal chamber 24. As shown in FIG. 1, a breaking line 28 for breaking the glass substrate 22 at a portion corresponding to the driving electrodes 27 is formed on the outer surface of the glass substrate 22.

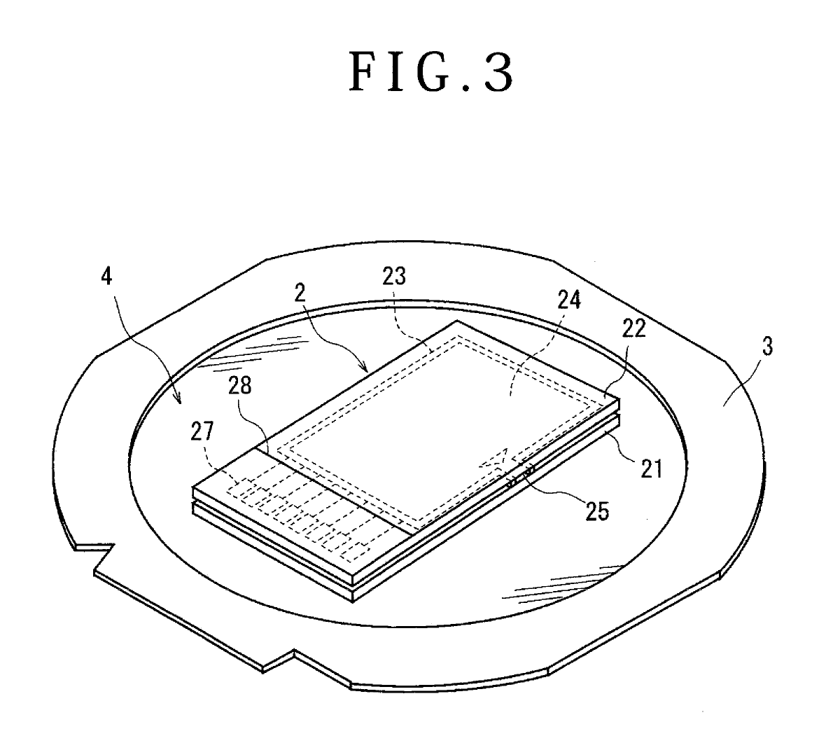

Prior to breaking the glass substrate 22 along the breaking line 28, the silicon substrate 21 is attached to the upper surface of a holding tape 4 mounted on an annular frame 3 as shown in FIG. 3. The holding tape 4 is formed from a synthetic resin sheet of polyolefin or the like. Accordingly, the liquid crystal device 2 is supported through the holding tape 4 to the annular frame 3 in the condition where the glass substrate 22 is oriented upward.

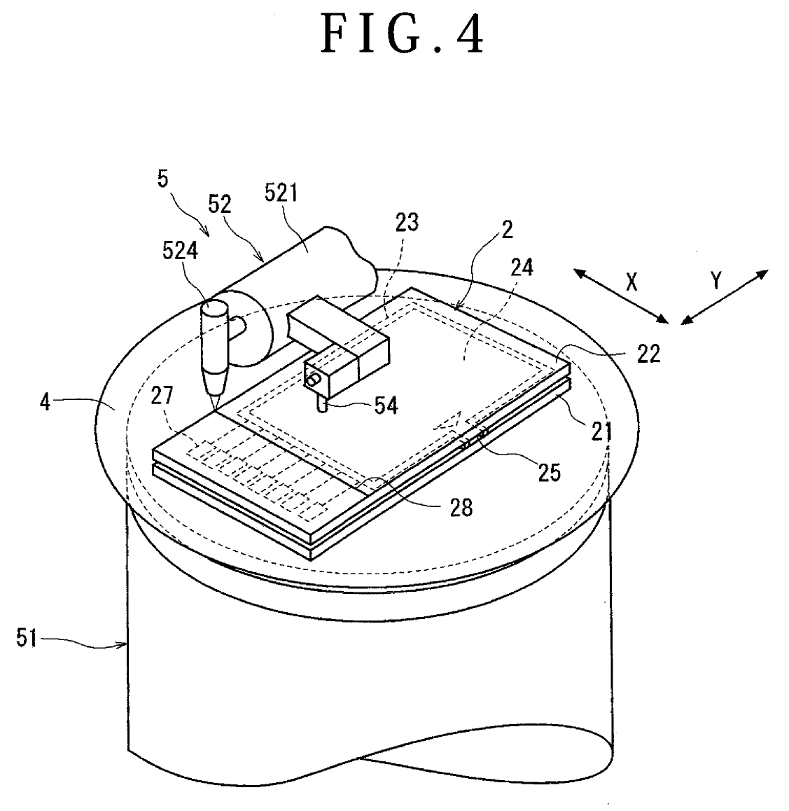

The glass substrate 22 of the liquid crystal device 2 is processed by a laser processing method such that a laser beam is applied to the outer surface of the glass substrate 22 along the breaking line 28 to thereby form a laser processed groove on the outer surface of the glass substrate 22. FIG. 4 shows a laser processing apparatus 5 for applying a laser beam to the outer surface of the glass substrate 22 of the liquid crystal display 2 along the breaking line 28. The laser processing apparatus 5 shown in FIG. 4 includes a chuck table 51 for holding a workpiece and laser beam applying means 52 for applying a laser beam to the workpiece held on the chuck table 51. The chuck table 51 is so configured as to hold the workpiece by suction. The chuck table 51 is movable by a feeding mechanism (not shown) in a feeding direction shown by an arrow X in FIG. 4 and also movable by an indexing mechanism (not shown) in an indexing direction shown by an arrow Y in FIG. 4.

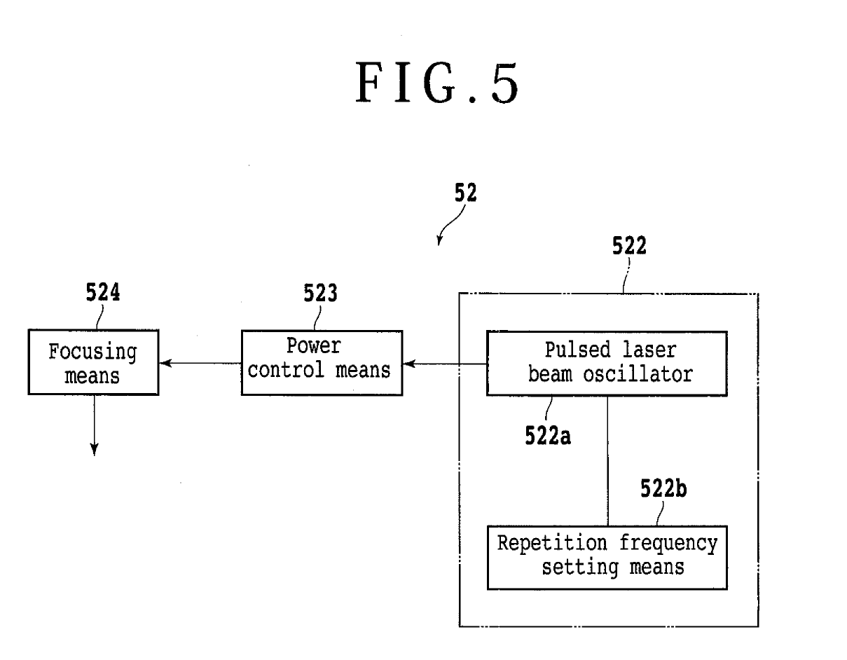

The laser beam applying means 52 includes a cylindrical casing 521 extending in a substantially horizontal direction. As shown in FIG. 5, pulsed laser beam oscillating means 522 and power control means 523 are provided in the casing 521. The pulsed laser beam oscillating means 522 is composed of a pulsed laser beam oscillator 522a and repetition frequency setting means 522b connected to the pulsed laser beam oscillator 522a. The pulsed laser beam oscillator 522a is provided by a YAG laser oscillator or a YVO4 laser oscillator. The pulsed laser beam oscillator 522a functions to oscillate a pulsed laser beam having an absorption wavelength (e.g., 355 nm) to the glass substrate 22.

The repetition frequency setting means 522b functions to set the repetition frequency of the pulsed laser beam to be oscillated from the pulsed laser beam oscillating means 522. The power control means 523 functions to control the power of the pulsed laser beam oscillated from the pulsed laser beam oscillating means 522 to a desired value. The pulsed laser beam oscillating means 522 and the power control means 523 are controlled by control means (not shown). Focusing means 524 having a focusing lens (not shown) is mounted on the front end of the casing 521. The focusing lens is provided by a combination lens well known in the art. The focusing means 524 functions to focus the pulsed laser beam oscillated from the pulsed laser beam oscillating means 522 to a predetermined spot diameter and to apply this focused beam to the workpiece held on the chuck table 51.

As shown in FIG. 4, the laser processing apparatus 5 further includes imaging means 54 mounted on the front end portion of the casing 521 of the laser beam applying means 52. The imaging means 54 functions to image the workpiece held on the chuck table 51. The imaging means 54 includes an optical system and an imaging device (CCD) and functions to supply an image signal corresponding to the image of the workpiece to the control means (not shown).

There will now be described a laser processing method for forming a laser processed groove on the outer surface of the glass substrate 22 along the breaking line 28 by using the laser processing apparatus 5 shown in FIG. 4. As shown in FIG. 3, the liquid crystal device 2 supported through the holding tape 4 to the annular frame 3 is placed on the chuck table 51 of the laser processing apparatus 5 shown in FIG. 4 and held thereon by suction in the condition where the glass substrate 22 is oriented upward. While the annular frame 3 on which the holding tape 4 is mounted is not shown in FIG. 4, the annular frame 3 is clamped to the chuck table 51 by any suitable clamping means.

The chuck table 51 holding the liquid crystal device 2 thereon is moved to a position directly below the imaging means 54 by the feeding mechanism (not shown). When the chuck table 51 is moved to the position directly below the imaging means 54, an alignment operation for detecting a laser processing region on the liquid crystal device 2 is performed by the imaging means 54 and the control means (not shown). More specifically, the imaging means 54 and the control means (not shown) perform the alignment operation for a laser beam applying position such that the breaking line 28 formed on the glass substrate 22 of the liquid crystal device 2 is aligned to the focusing means 524 of the laser beam applying means 52 for applying the laser beam along the breaking line 28.

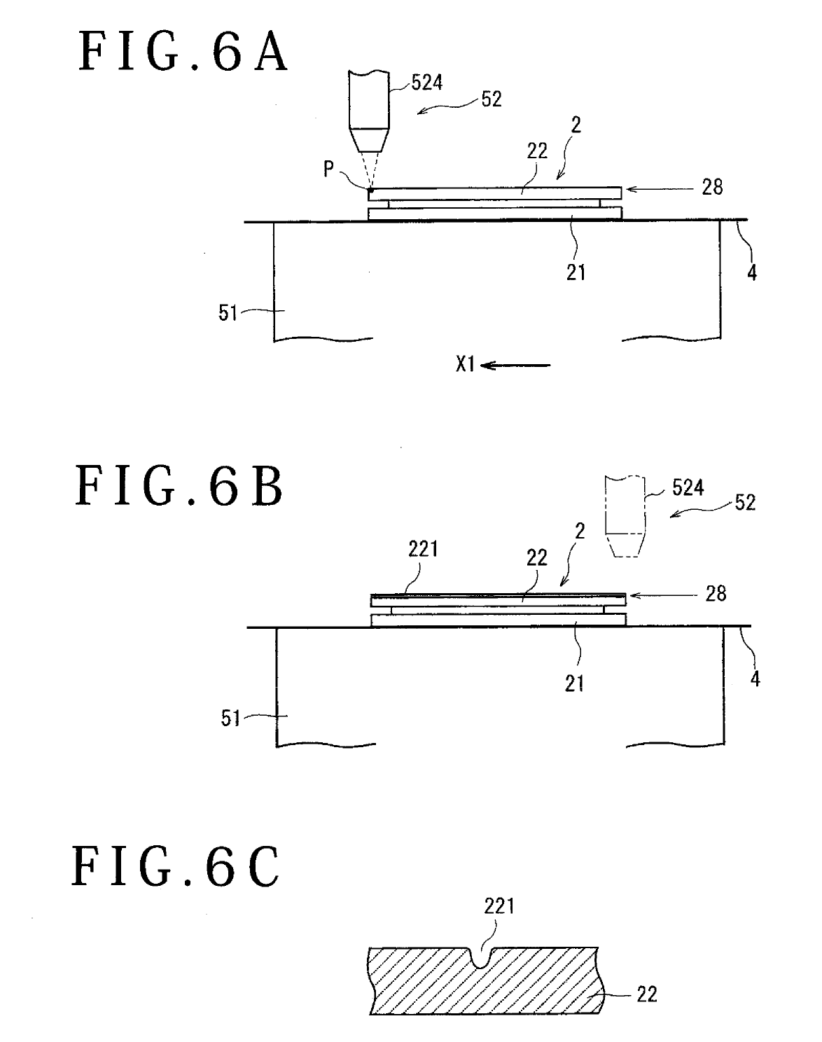

Thus, the alignment operation for the laser beam applying position is performed to detect the breaking line 28 formed on the glass substrate 22 of the liquid crystal device 2 held on the chuck table 51. Thereafter, as shown in FIG. 6A, the chuck table 51 is moved to the laser beam applying position where the breaking line 28 is positioned directly below the focusing means 524 of the laser beam applying means 52 for applying the laser beam. More specifically, as shown in FIG. 6A, one end of the breaking line 28 (left end as viewed in FIG. 6A) is positioned directly below the focusing means 524.

Thereafter, a pulsed laser beam having an absorption wavelength (e.g., 355 nm) to the glass substrate 22 is applied from the focusing means 524 of the laser beam applying means 52 to the glass substrate 22, and simultaneously the chuck table 51 is moved in the direction shown by an arrow X1 in FIG. 6A at a predetermined feeding speed. When the other end of the breaking line 28 (right end as viewed in FIG. 6B) reaches a position directly below the focusing means 524 as shown in FIG. 6B, the application of the pulsed laser beam is stopped and the movement of the chuck table 51 is also stopped. In this laser beam applying step, the focal point P of the pulsed laser beam is set near the outer surface (upper surface) of the glass substrate 22. As a result, a laser processed groove 221 is formed along the breaking line 28 on the outer surface (upper surface) of the glass substrate 22 of the liquid crystal device 2 as shown in FIGS. 6B and 6C.

The processing conditions in the laser beam applying step will now be described. The present inventors have performed an experiment to find that when the repetition frequency of a pulsed laser beam applied to a glass plate is set to a value less than 200 kHz, e.g., 100 kHz, cracks are generated in the glass plate, whereas when the repetition frequency of the pulsed laser beam is set to a value greater than or equal to 200 kHz, no cracks are generated in the glass plate. This may be due to the following fact. That is, when the repetition frequency of the pulsed laser beam is low, the application period of pulses is long, so that a cooling time becomes long and a tensile stress due to cooling is generated to cause the cracks. Conversely, when the repetition frequency of the pulsed laser beam is high, the application period of pulses is short, so that heat by the pulse previously applied is left at the time the next pulse is applied. Accordingly, a tensile stress due to cooling is not generated, resulting in no cracks in the glass plate. Accordingly, it is necessary to set the repetition frequency of the pulsed laser beam to a value greater than or equal to 200 kHz. Further, according to the experiment conducted by the present inventors, it has been found that when the pulse width of the pulsed laser beam is greater than 10 ns, cracks are easily generated. Accordingly, it is preferable to set the pulse width of the pulsed laser beam to a value less than or equal to 10 ns.

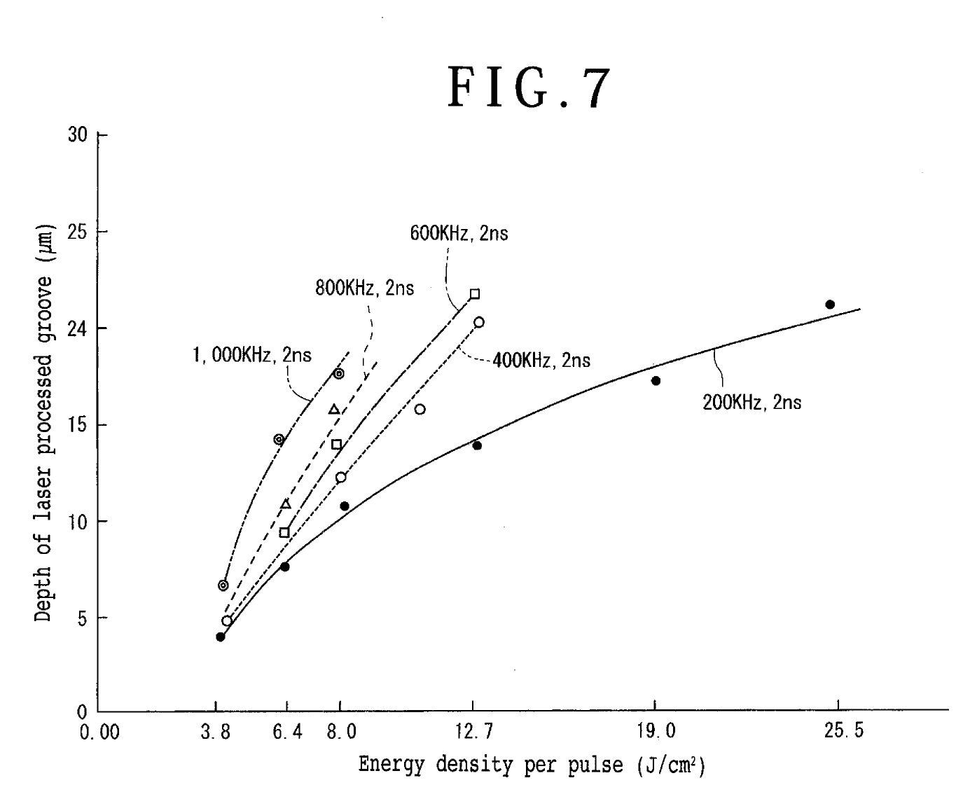

There will now be described the energy of a pulsed laser beam required for the formation of a laser processed groove on a glass plate. FIG. 7 shows experimental data obtained by measuring the depth of a laser processed groove formed on a glass plate having a thickness of 1 mm by applying a pulsed laser beam. In this measurement, the repetition frequency of the pulsed laser beam was set to 200 kHz, 400 kHz, 600 kHz, 800 kHz, and 1000 kHz. The pulse width was set to 2 ns for each value for the repetition frequency. Further, the focused spot diameter of the pulsed laser beam applied from the focusing means 524 of the laser beam applying means 52 was set to 10 μm, and the rate of overlapping of the focused spots was set to 98%. In FIG. 7, the horizontal axis represents the energy density (J/cm²) per pulse of the pulsed laser beam, and the vertical axis represents the depth (μm) of the laser processed groove formed on the glass plate.

As apparent from FIG. 7, when the energy density per pulse is less than 3.8 J/cm² in each repetition frequency, the laser processed groove is not formed on the glass plate. Further, the higher the repetition frequency and the higher the energy density per pulse, the larger the depth of the laser processed groove formed on the glass plate. Further, when the repetition frequency of the pulsed laser beam becomes greater than or equal to 400 kHz and the energy density per pulse becomes greater than or equal to 8 J/cm², the depth of the laser processed groove is rapidly increased as compared with the case that the repetition frequency is 200 kHz. Accordingly, it is necessary to set the energy density per pulse of the pulsed laser beam to a value greater than or equal to 3.8 J/cm². Further, it is preferable to set the repetition frequency of the pulsed laser beam to a value greater than or equal to 400 kHz and the energy density per pulse to a value greater than or equal to 8 J/cm².

Further, the rate of overlapping of the focused spots of the pulsed laser beam is preferably set to 50% or more in order to straight and continuously form the side wall of the laser processed groove. According to the experiment conducted by the present inventors, similar effects can be obtained in the case that the transparent plate is formed of quartz, sapphire, or lithium tantalate.

By setting the above-mentioned processing conditions for the pulsed laser beam to be applied along the breaking line 28 formed on the glass substrate 22 of the liquid crystal device 2, the pulsed laser beam applied to the glass substrate 22 can be used for the formation of the laser processed groove. Accordingly, there is no possibility that the pulsed laser beam may pass through the glass substrate 22 to damage the driving electrodes 27 formed on the inner surface of the silicon substrate 21, i.e., on the surface exposed to the liquid crystal chamber 24.

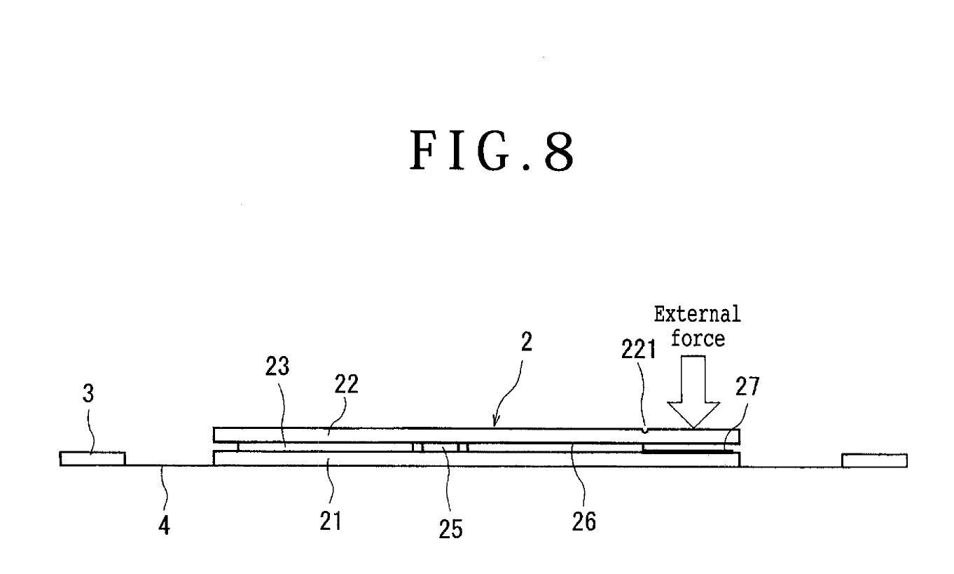

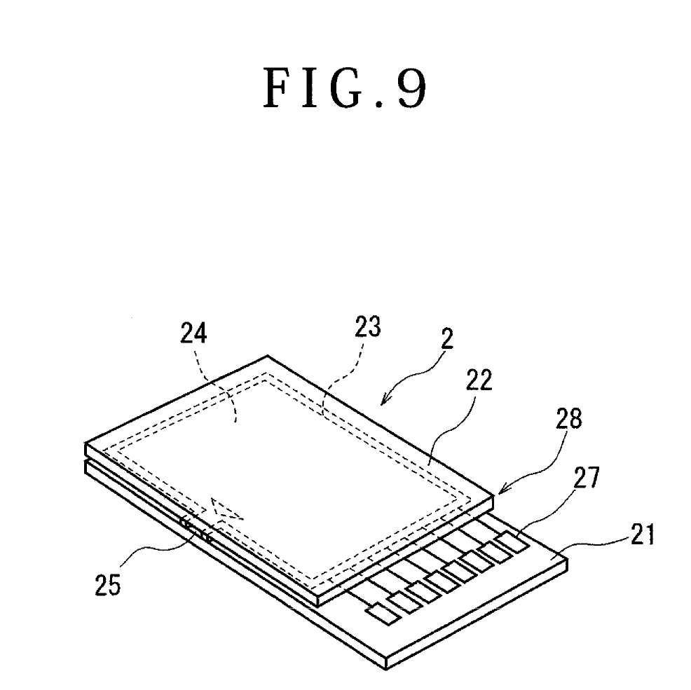

After forming the laser processed groove 221 along the breaking line 28 on the outer surface of the glass substrate 22 of the liquid crystal device 2, the liquid crystal device 2 held on the chuck table 51 is transferred from the chuck table 51 to a position where a breaking step as the next step is to be performed. In this breaking step, an external force is applied along the laser processed groove 221 formed on the glass substrate 22 of the liquid crystal device 2 as shown in FIG. 8. As a result, the glass substrate 22 of the liquid crystal device 2 is broken along the breaking line 28 as shown in FIG. 9 to thereby remove a portion 22a (see FIG. 8) of the glass substrate 22 above the driving electrodes 27. Accordingly, the driving electrodes 27 of the liquid crystal device 2 are exposed as shown in FIG. 9.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing method for a transparent plate having a predetermined breaking line, comprising the step of:
applying a pulsed laser beam having an absorption wavelength to said transparent plate along said breaking line to form a laser processed groove, wherein
the repetition frequency of said pulsed laser beam is set to 200 kHz or more and the energy density per pulse of said pulsed laser beam is set to 3.8 j/cm² or more.

2. The laser processing method according to claim 1, wherein the repetition frequency of said pulsed laser beam is set to 400 kHz or more and the energy density per pulse of said pulsed laser beam is set to 8 J/cm² or more.

3. The laser processing method according to claim 1, wherein the pulse width of said pulsed laser beam is set to 10 ns or less.

4. The laser processing method according to claim 1, wherein the rate of overlapping of focused spots of said pulsed laser beam is set to 50% or more.
